(19) United States
(12) Patent Application Publication
(10) Pub. No.: US 2004/0079442 A1
(43) Pub. Date: Apr. 29, 2004

(54) System for cleaning and servicing engines

(76) Inventor: Robert E. Flynn, Covina, CA (US)

Correspondence Address: Boniard I. Brown, #113, 1500 West Covina Parkway, West Covina, CA, 91790-2793, US

(21) Appl. No.: 10/283,678

(22) Filed: Oct. 29, 2002

(51) Int. Cl. B65B 3/04; B67C 3/02; B65B 1/04

(52) U.S. Cl. 141/98

(57) ABSTRACT

An engine cooling system liquid insertion and removal system has an adapter disposed in a radiator service opening via which old coolant is removed from the engine system by partial vacuum applied to an old coolant container via a conduit, and new coolant is introduced by atmospheric pressure. Conduits interconnect the engine cooling system, old and new coolant containers, and a source of partial vacuum applied to certain conduits.

### BACKGROUND AND SUMMARY OF THE INVENTION

There has long existed a need for a coolant removal and replacement system to provide prompt and efficient extraction of coolant and insertion of new coolant to a vehicle engine system.

The prior art methods typically involve a cone-shaped adapter inserted in the vehicle radiator service opening, which does not allow escape of air trapped in the coolant system, particularly when partial vacuum is employed to draw coolant into a system, particularly when partial vacuum is employed to draw coolant into a system. Radiator hoses must be disconnected and the adapter connected into the radiator hose. A problem has been involved in that many radiator hoses are not sufficiently rigid so that they partially collapse up0on introduction of a partial vacuum into the system. Thus, only part of the coolant is removable without substantial additional procedures and effort. Thus, coolant must be removed from an engine by other means, and air must be allowed to enter the system to enable a radiator hose to regain its original uncollapsed condition. Coolant must then be installed and a new partial vacuum drawn on the system. All such procedures are time consuming, and can result in old coolant remaining in the engine with resultant low or incomplete fill, with replacement of only less than a full supply of coolant.

The present invention provides an adapter for vehicle radiator service openings so that coolant can be removed from the coolant system by partial vacuum. Partial vacuum is provided by a service pump of the system, or by a venturi. Only limited introduction of atmospheric pressure is needed to greatly enhance passage of coolant from a container into an engine system, particularly when the engine coolant level is quite low in relation to the capacity of the system. No hose or conduit is disconnected or reconnected.

Other liquids than coolants may be utilized with the invention, such as cleaning solutions or antifreeze.

The system substantially insures against liquid spilling, in contrast with the prior art, this being important in view of environmental regulations relative to disposing of certain substances, such as certain antifreezes.

The invention is preferably utilized with a console whereon are mounted or attached components according to the invention, these including old and new coolant containers, conduits interconnecting an engine interior with old coolant container, a new coolant container and conduit interconnecting it via an adapter for insertion of new coolant into an engine by only atmospheric pressure. Means are provided for the application of partial vacuum to an old coolant container to draw coolant from the engine to the container, and means are provided for application of atmospheric pressure to a new coolant container to urge the coolant into the engine.

### BRIEF DESCRIPTION OF THE DRAWINGS

FIG. 1 is a perspective view of a console whereon components according to the invention are disposed;

FIG. 2 is a diagrammatic showing of a system according to the invention for the removal of old coolant from a vehicle engine;

FIG. 3 is a diagrammatic showing of a system according to the invention for insertion of new coolant into the vehicle engine;

FIG. 4 is a diagrammatic showing of an arrangement of components for insertion of new coolant into the system;

FIG. 5 is a diagrammatic showing of an arrangement of the system components for the removal of old coolant from the system;

FIG. 6 is a sectional view showing details of a container according to the invention;

FIG. 7 is a sectional view of an adapter utilized in the invention; and

FIG. 8 is a diagrammatic view of the system of the invention wherein four liquid containers are utilized together with associated conduits and valving.

### DESCRIPTION OF THE PREFERRED EMBODIMENTS

The present invention relates to a system for the removal of old coolant from a vehicle engine and replacement thereof with new coolant.

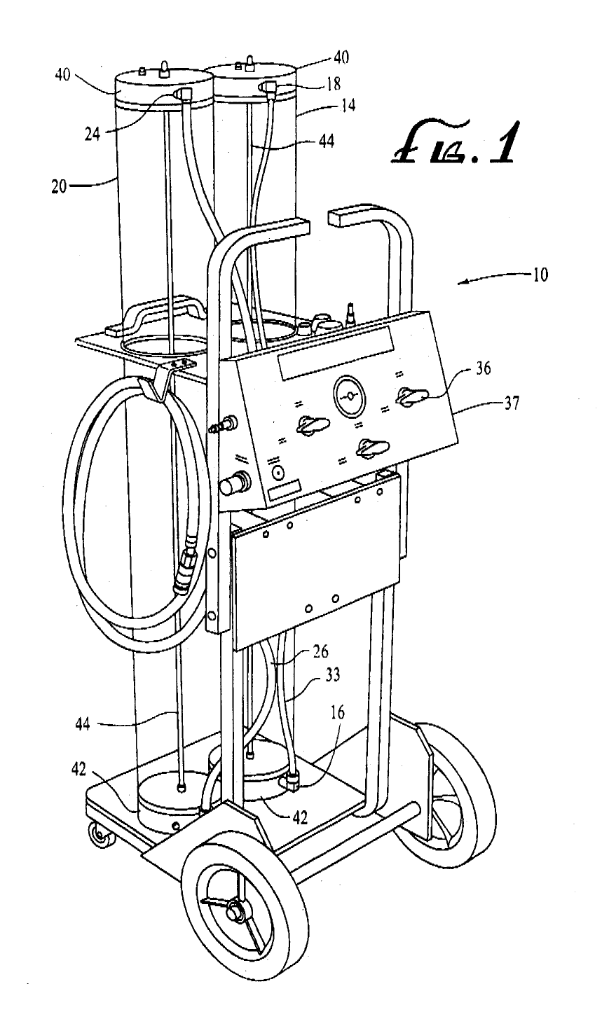

Referring to the drawings, FIG. 1 shows a console 10 on which components according to the invention are mounted for efficient and convenient control of these components including various valves and conduits having various interconnections during operation of the system according to the invention.

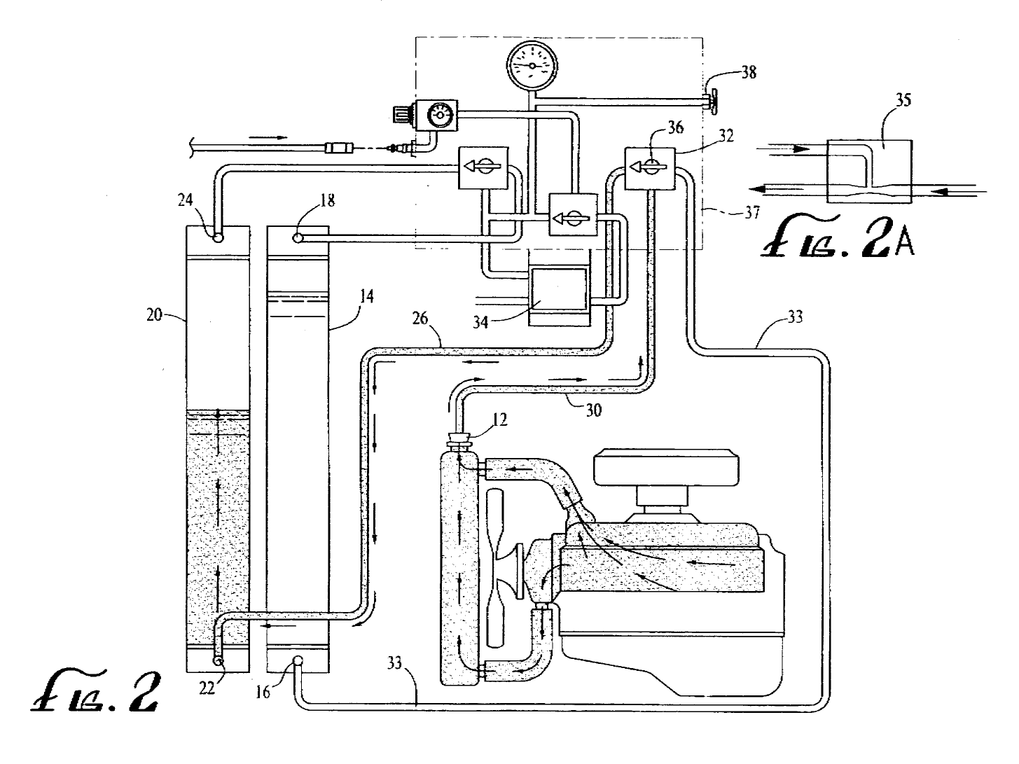

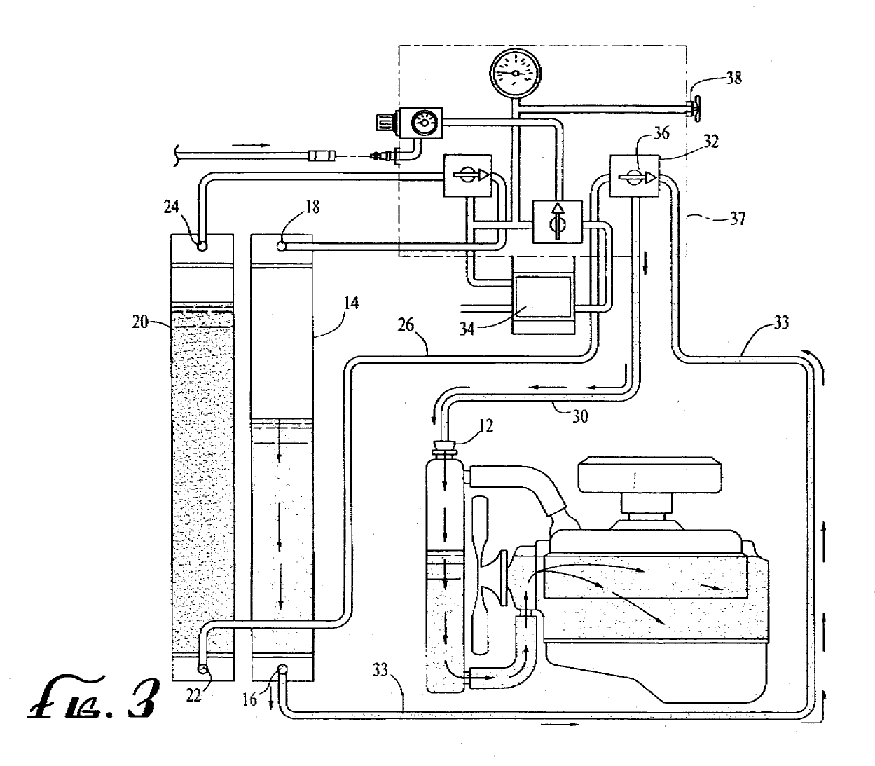

FIGS. 2 and 3 respectively show the system arranged for the removal of coolant from a vehicle engine, and arranged for installing new coolant into the engine.

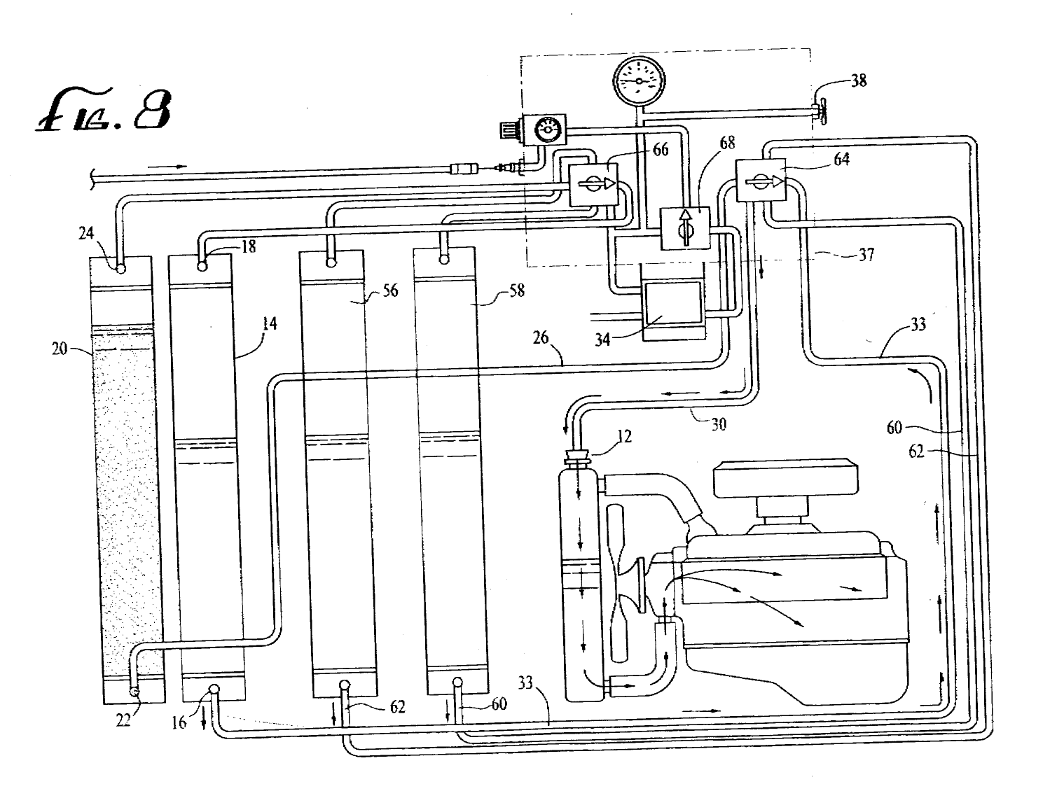

An adapter 12 is installed in a vehicle radiator service opening, and is formed of a resilient material, typically rubber, and, as shown in FIG. 7, has an axial passage 13 therethrough. A threaded end portion of a fluid conduit is disposed in an upper portion of the passage.

As shown in FIGS. 2 and 3, the system comprises a new coolant container 14 having an inlet opening 16 in its lower portion and an outlet opening 18 in its upper portion. An old solution container 20 has an inlet opening 22 in its lower portion and an outlet opening 24 in its upper portion. An old solution conduit 26 interconnects an engine interior via the adapter 12, valve 32, conduit 26 and inlet opening 22 of the old coolant container for transfer of old solution from the engine into the container. New coolant container inlet opening 16 is connected by conduit 33, valve 32 and conduit 30 for drawing new coolant from container or tube 14 into an engine radiator via adapter 12, the new coolant being urged by partial vacuum in an upper portion, which vacuum is produced by a pump 34 or venturi 35.

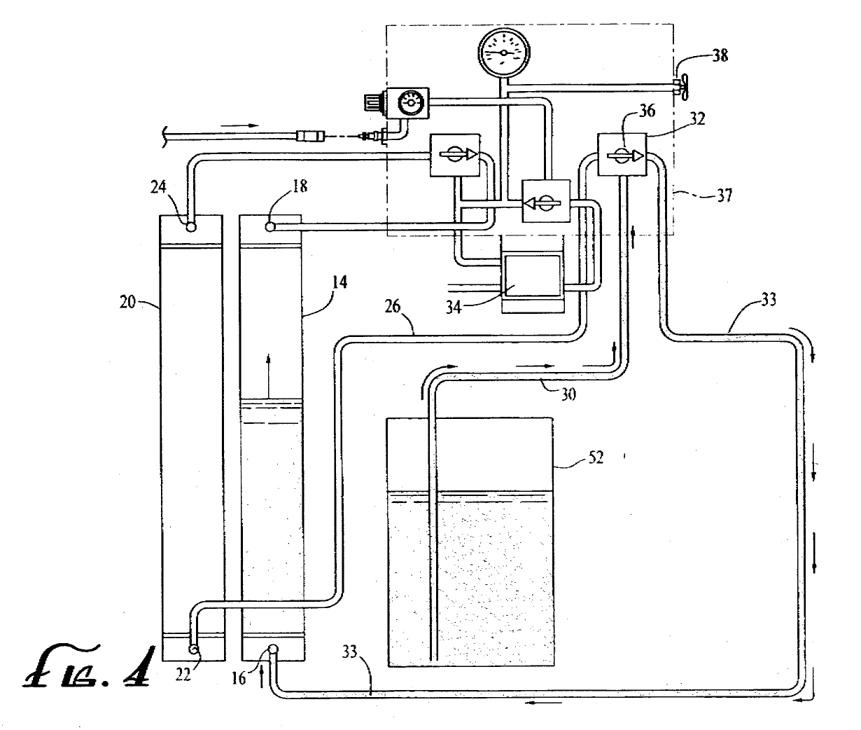

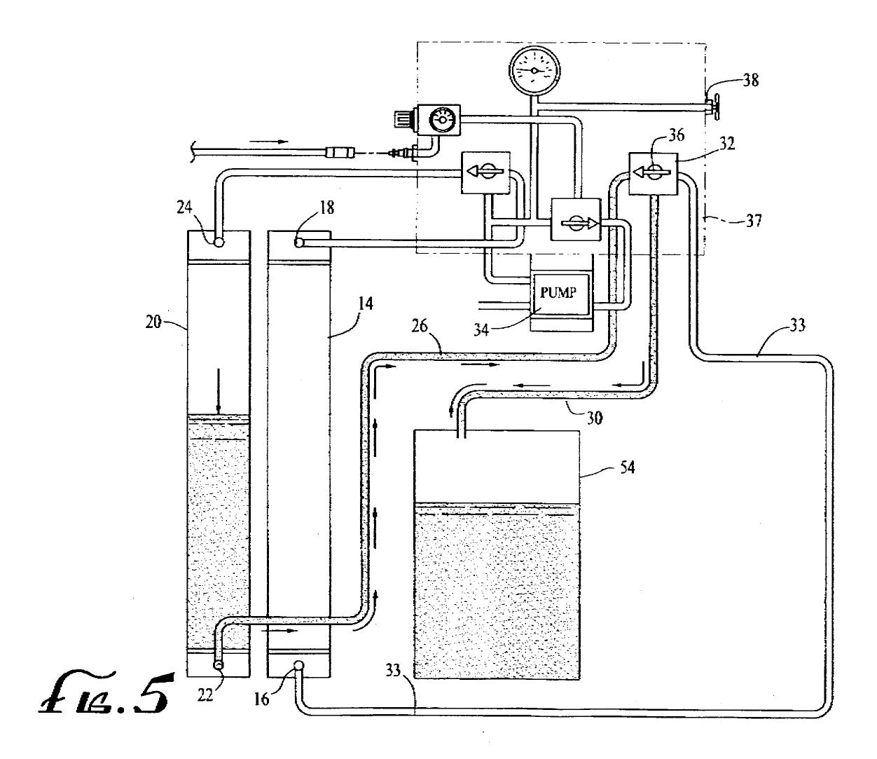

Preferably, the console 10 has thereon an old coolant container 20, a new coolant container 14, valves and conduits to interconnect conduits and valves, as indicated in FIG. 1. In principal, control 36 on a console 37 is operable to provide quick, efficient changes in liquid flow via valves and conduits of the system to operate valves to effect respective flow patterns via particular conduits, thus to provide for removal of old coolant from an engine, insertion of new coolant into an engine, draining of the system of old coolant, and the filling of the system with a new coolant. The system and interconnections for these operations are illustrated in FIGS. 2 through 5, FIG. 2 showing the arrangement for removal of old coolant from a vehicle engine, FIG. 3 shows the arrangement for insertion of new coolant into an engine, FIG. 4 shows the arrangement for introduction of a supply of coolant into the system, and FIG. 5 shows the arrangement for draining old coolant from the system.

The tubes or containers 14, 20 utilized with the invention are interchangeable, and each can perform the function of the others. FIGS. 2 through 5 show the utilization of two tubes. As later described, three or four tubes may be utilized.

The partial vacuum for drawing old coolant from an engine is provided by a venturi or a piston-type pump 34. A venturi 35 (FIG. 2A) is preferred because it provides a higher degree of partial vacuum than a pump of similar size and capacity. The venturi itself is conventional, comprising a tube having a tapered restriction at its mid-portion to cause an increase in velocity of a fluid passing through the restriction and a corresponding decrease in fluid pressure, thus creating and providing suction.

The boiling point of the water is reduced to 160°-180°, depending on the partial vacuum provided. Boiling water causes the water density to become lighter and it can be pulled from the engine with the partial vacuum.

The new coolant entering the engine by application of atmospheric pressure avoids any spraying of a person or persons which might occur at a higher pressure, such as 70 psi.

The present invention eliminates disconnecting and/or reconnecting fluid conduits during the removal of old coolant and insertion of new coolant; into an engine. Cleaning and flushing are accomplished in the removal of old coolant continuously during coolant changing.

The system operates whether or not the engine is running, but preferably with the engine running because it is not advisable to put cool coolant into a hot engine.

A small valve 38 is utilized for bleed-off because when the partial vacuum is applied, the liquid in the tube boils. The relief valve may be operated to prevent persons from being excited by the boiling action.

A control valve can be operated to open in order to mix water and coolant before it passes to an engine. Leaving a service hose or conduit open to atmosphere during drawing a vacuum in a tube creates turbulence for better mixing of the liquids.

A filter pump and assembly (not shown) may be used in extracting solution from the bottom of a tube by a filter back into the top of the tube. A filter bowl is removed and cleaning agent poured into the filter bowl, and the pump is then started to mix the cleaning agent to enhance its effectiveness.

The tubes or containers 14, 20 are preferably transparent to enable visual observation of the coolant, and for display of old coolant to customers to determine whether the coolant should be replaced.

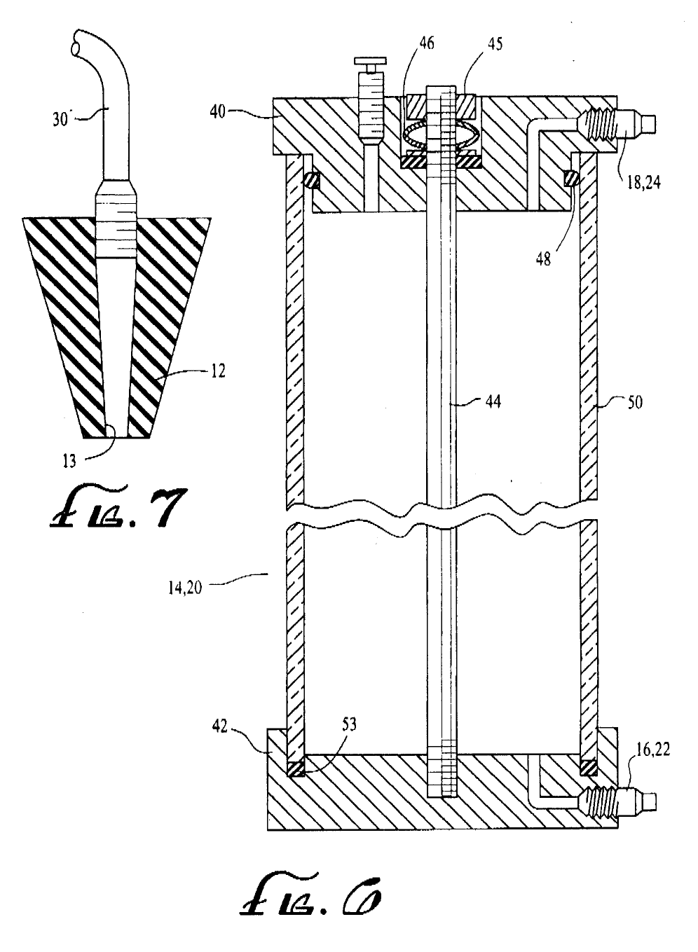

The sectional view of FIG. 6 shows in a cross-sectional view the tube or container structure. The containers or tubes 20, 14 comprise a top member 40 and a bottom member 42 secured together by a threaded tie-rod 44 and a nut 45 which compress a pair of curved spring members 46 and a resilient member, as shown, and which threadedly engages the bottom member. An O-ring seal 48 is disposed between the top member and housing 50.

A resilient O-ring seal 53 is disposed in an annular groove in bottom member 42 and engages the lower edge of housing 50. This sealing arrangement is utilized because the inner diameter of the housing 50 cannot be well controlled in its manufacture. Too small a ring will cause greater pressure to be applied by the O-ring. If a tube is too large, an O-ring will not provide adequate pressure sealing, with resultant leakage. The tube is subject to very heavy vacuum loads, particularly when a partial vacuum urges the upper and lower caps of the tube assembly together, and good sealing is important.

FIG. 4 illustrates the insertion of new coolant into the piston. New coolant is drawn from a tank or container 52 and passes via valve 32 and conduit 33 to inlet opening 16 of the new coolant tube or container 14.

FIG. 5 shows the system arranged for withdrawal of old coolant from old coolant tank 20 via conduit 30, valve 32 and line 26, and disposing the coolant into a container or drum 54.

FIG. 8 shows an embodiment of the present invention wherein additional tubes or containers 56, 58 are provided. These are similar to tubes 14, 20 of FIGS. 2 and 3, typically. The tubes 56, 58 may be employed to serve additional functions, such as the provision of anti-freeze solution to an engine coolant system, providing cleaning solution to an engine, and may also serve to provide additional old coolant volume and/or new coolant volume. These tubes function generally in the manner of the operation of tubes 14, 20 of the embodiments of FIGS. 1 to 5. The valves 64, 66, 68 may be provided with additional ports and additional conduits such as conduits 60 and 62 shown in FIG. 8.

It will be understood that various changes and modifications may be made from the preferred embodiments discussed above without departing from the scope of the present invention, which is established by the following claims and equivalents thereof.

The inventor claims:

1. A vehicle engine coolant changing system comprising:
a new coolant container having an inlet opening and an outlet opening,
an old coolant container having an inlet opening and an outlet opening,
an adapter disposed in the engine radiator service opening and having a passage therethrough,
an old solution conduit interconnecting an engine interior and said inlet opening of the old coolant container to transfer old coolant from the engine interior to the old coolant container,
a conduit interconnecting the new coolant container and said adapter to urge new coolant from the new coolant container into the engine by atmospheric pressure,
means to apply a partial vacuum to said old coolant container to draw old coolant from the engine interior into the old coolant container,
a new coolant conduit interconnecting said new coolant container and said adapter, and
means to apply atmospheric pressure to the new coolant in the new coolant container to urge the new coolant into the engine.

2. A system according to claim 1, wherein said adapter has a tapered configuration to engage in service openings of the various sizes.

3. A system according to claim 1, wherein said new coolant container and old coolant container are of generally tubular configuration.

4. A system according to claim 1, wherein inlet and outlet openings are respectfully disposed in either upper portions or lower portions of said coolant containers.

5. A system according to claim 1, wherein each of said containers is sealed at its top and bottom.

6. A system according to claim 1, wherein removable coolant and insertion of new coolant connected to an engine is without disconnecting and re-connecting of conduits.

7. A system according to claim 1 wherein cleaning and flushing of a coolant system is effected concurrently with changing of the coolant.

8. A system according to claim 1 wherein said partial vacuum is produced by a pump.

9. A system according to claim 1 wherein said partial vacuum is produced by a venturi.

10. A system according to claim 1, wherein said new and old coolant containers and said valves are disposed on a console.

11. A system according to claim 1, wherein a single control is operable to provide rapid and efficient changes in flow patterns via conduits and valves of the system.

12. A console-mounted system including valves and conduits for insertion of liquids into an engine and removal therefrom, said system comprising:
a new coolant container and an old coolant container, each having an inlet and an outlet opening,
an adapter disposed in an engine radiator service opening and having a passage therethrough for exit of old coolant from said engine and entry of new coolant thereto,
a first conduit connected with said console and interconnecting the interior of the engine and the inlet opening of the old coolant container,
means to pump old coolant from the engine via the first conduit to the old coolant container,
means attached to the console to apply a partial vacuum in the old liquid container to draw old liquid from the engine interior to the old liquid container,
a new liquid conduit interconnecting the new liquid container and said adapter for passage of the new coolant from the new coolant container to the engine by atmospheric pressure,
means to apply the atmospheric pressure to urge the new coolant in the new coolant container into the engine, and
a unitary control at the console operable to provide rapid and efficient changes of interconnections between valves and conduits.

13. A system according to claim 12, wherein said unitary control is rotatable to selected positions to effect selected changes in flow via respective conduits and valves.

14. A system according to claim 12, and further comprising at least one gauge at the console to provide indication of (a) pressure in a conduit, (b) flow rate in a conduit.

15. A system according to claim 12, wherein said unitary control comprises a rotatable member rotatable to selected positions, each respective position effecting a particular flow via respective conduits and valves.

16. A system according to claim 12 wherein said partial vacuum is provided by a pump at the console.

17. A system according to claim 12 wherein said partial vacuum is provided by a venturi connected with the console.

18. A system according to claim 12 wherein at least one of the containers comprises top and bottom members in sealing relation with a tubular body.

19. A system according to claim 18 wherein said body is formed of polycellfoam.

20. A system according to claim 18 wherein said body is formed of a blend of polycarbonate and polyester.

21. A system for insertion of liquids into and removal removable therefrom a vehicle engine, comprising:
a plurality of at least three respective containers for respective liquids for insertion into and removal from said engine,
each of said containers being interchangeable with the other containers, and each having compatible intake and outlet openings and conduit connections,
two of said containers respectively containing new coolant and old used coolant,
an adapter disposed in an engine radiator service opening and having a passage therethrough,
conduit means to interconnect the old coolant container and the engine for drawing old coolant from the engine via said adapter and at least one conduit to the old coolant container from the engine by application of partial vacuum in the old coolant container,
means to provide said partial vacuum in the 0old coolant container, and
one of said containers having therein one of (a) engine antifreeze for passage by a conduit to the engine by application of partial vacuum in said container, (b) a cleaning solution for passage to the engine by application of partial vacuum in said container by a conduit.

22. A system according to claim 21 wherein the partial vacuum is provided by a pump.

23. A system according to claim 21 wherein said partial vacuum is provided by a venturi.

24. A system according to claim 21 and further comprising a single control rotatable among respective positions to effect respective changes of flow via at least one conduit and at least one valve.

25. A system according to claim 21 wherein the plurality of containers have at least two containers, each having a top member, a bottom member and a tubular body member.

26. A system according to claim 25 wherein said tubular body is formed of polycellfoam.

27. A system according to claim 25 wherein said tubular body is formed of a blend of polycarbonate and polyester.
